(19) United States
(12) Patent Application Publication
(10) Pub. No.: US 2014/0316961 A1
(43) Pub. Date: Oct. 23, 2014

(54) Dynamic Tick Size Order Aggregator

(71) Applicant: CHICAGO MERCANTILE EXCHANGE, INC., Chicago, IL (US)

(72) Inventors: James Boudreault, Palatine, IL (US); Frederick Sturm, Chicago, IL (US); John Labuszewski, Westmont, IL (US); Daniel Grombacher, Evanston, IL (US); Richard Co, Chicago, IL (US)

(21) Appl. No.: 13/868,781

(22) Filed: Apr. 23, 2013

(51) Int. Cl. G06Q 40/00

(52) U.S. Cl. CPC G06Q 40/04
USPC 705/37

(57) ABSTRACT

Systems and methods are provided for dynamically adjusting a bid ask spread while maintaining a fixed trading increment. Various criteria may be analyzed to determine if a bid ask spread meets the desired criteria. When the criteria is not met, the bid ask spread may be adjusted by aggregating orders. Aggregation may include raising a price of the lowest ask prices and/or lowering a price of the highest bid orders.

### FIELD OF THE INVENTION

The present invention relates to financial product trading systems and, in particular, to methods and systems that allow for dynamic adjustment to a bid ask spread.

### DESCRIPTION OF THE RELATED ART

Financial instruments are generally traded at exchanges and other entities by listing bid and ask orders at different price levels. Trading increments are set so that financial instruments trade at established price levels. For example, a financial instrument having a trading increment of 0.01 may list at an exchange at price levels of 95.26, 95.27 and 95.28. Trading increments may be determined for each financial product. Typically higher volatility financial instruments have relatively higher trading increments so that there are a reasonable number of price levels. Trading increments are generally set when a financial product is designed. If trading increments are too small, there can be a limited quantity of financial instruments available at each price level, resulting in spreading out of liquidity. Liquidity can also be reduced if the trading increments are too large, resulting in lower trading volumes. Regulatory requirements and other issues can make changing trading increments burdensome and time consuming.

A bid ask spread is the price difference between the highest bid and the lowest ask, which represents the difference in price between the highest price that a buyer is willing to pay for a financial instrument and the lowest price for which a seller is willing to sell a financial instrument. Minimum bid ask spreads generally correspond to trading increments. Smaller minimum bid ask spreads and trading increments tend to result in resting orders being spread out among multiple price levels, which can result in relatively smaller resting order sizes. Larger minimum bid ask spreads and trading increments tend to result in liquidity being concentrated at the top of an order book, but limit the price levels available for trading financial instruments. Selecting a trading increment and the corresponding minimum bid ask spread often results in compromises and less than optimum choices.

Therefore, there is a need in the art for improved systems and methods that provide greater flexibility in setting bid ask spreads and trading increments.

### SUMMARY OF THE INVENTION

Embodiments of the present invention overcomes problems and limitations of the prior art by providing trading methods and systems that allow for dynamic adjustment to a minimum bid ask spread. Various criteria may be analyzed, such as criteria relating to existing resting order sizes at specific price levels, such as at the best bid and/or the best ask, to determine if a bid ask spread meets the desired criteria. When the criteria is not met, the bid ask spread may be adjusted while maintaining a fixed trading increment. The adjustment to the bid ask spread may be performed by aggregating orders. Aggregation may include raising a price of the lowest ask prices and/or lowering a price of the highest bid orders.

In other embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention;

FIG. 2 illustrates a process that may be used to dynamically adjust a minimum bid ask spread, in accordance with an embodiment of the invention.

FIG. 3 illustrates an exemplary state of a market prior to a dynamic adjustment of the minimum bid as ask spread.

FIG. 4 illustrates an exemplary state of a market after a dynamic adjustment of the bid as ask spread, in accordance with an embodiment of the invention.

### DETAILED DESCRIPTION OF THE INVENTION

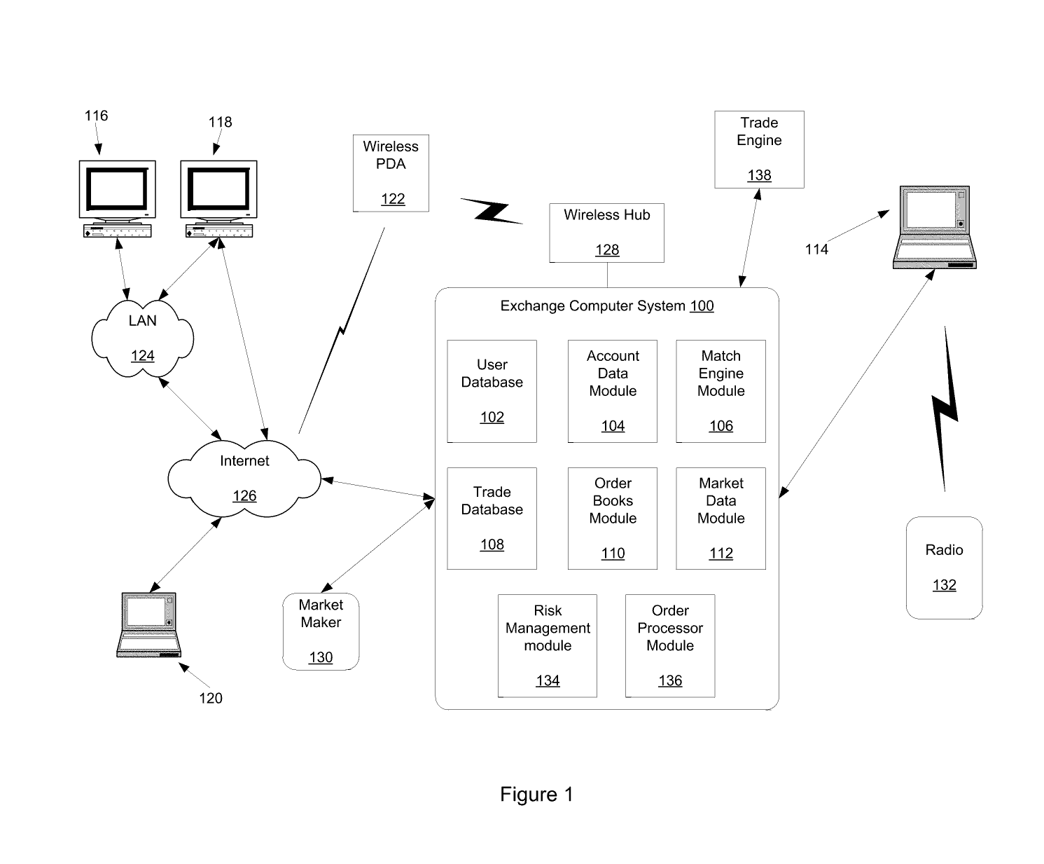

Aspects of the present invention are preferably implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords potentially with other information to identify users uniquely or collectively. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processor module 136 may be included to decompose variable defined derivative product and aggregate order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems. Coupling can be direct as described or any other method described herein.

The operations of computer devices and systems shown in FIG. 1 may be controlled by computer-executable instructions stored on a computer-readable medium. Various computer-readable media that are tangible and non-transitory may be used. In one example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

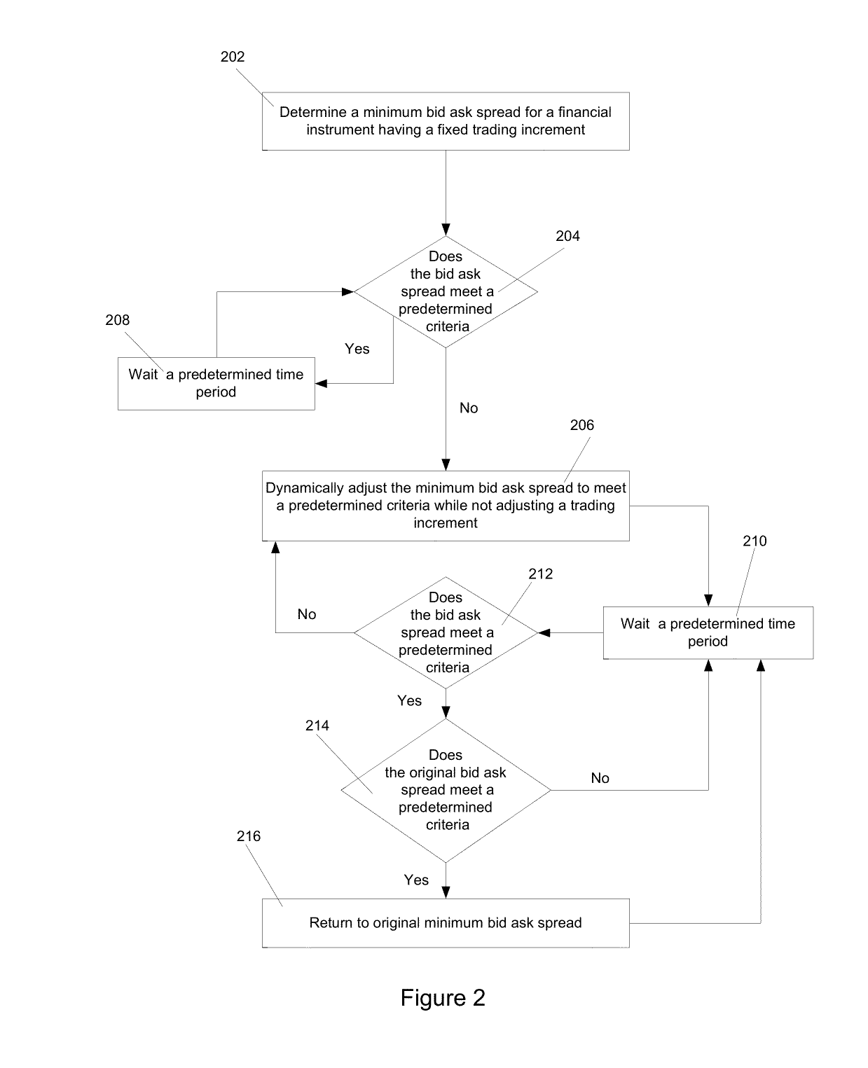

FIG. 2 illustrates a process that may be used to dynamically adjust a minimum bid ask spread, in accordance with an embodiment of the invention. First, in step 202 a minimum bid ask spread for a financial instrument having a fixed trading increment is determined. Step 202 may be performed when a new financial instrument is developed for trading and may be performed by an exchange or other entity. The initial minimum bid ask spread may be the same as the fixed trading increment. Next, it is determined whether the minimum bid ask spread meets a predetermined criteria in step 204. The predetermined criteria may include the quantity of resting orders on the best bid and/or best ask, an implied volatility of the financial instrument, realized volatility of the financial instrument, implied volatility of one or more underlying financial instruments or realized volatility of one or more underlying financial instruments. Some embodiments may alternatively or additionally consider factors such as an average daily volume of a financial instrument or open interest of the financial instrument. Step 204 may be performed by a processor executing computer-executable instructions that include criteria set by an exchange or other entity.

When the predetermined criteria is not met in step 204, in step 206 the minimum bid ask spread may be dynamically adjusted to meet the predetermined criteria. The adjustment to the minimum bid ask spread may be made while not adjusting the trading increment. The adjustment made in step 206 may include aggregating resting and incoming orders. For example, step 206 may include reducing a price of at least one bid order and/or increasing a price of at least one ask order. In some embodiments aggregation may be performed on the side of the market that initially has the fewest resting order quantities.

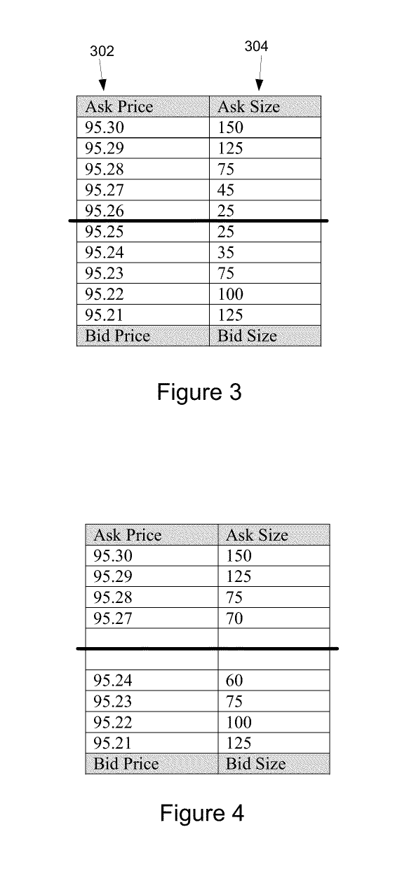

FIGS. 3 and 4 illustrate an exemplary operation of steps 204 and 206. FIG. 3 shows an initial state of a market for a financial instrument. Prices are shown in column 302 with a minimum trading increment of 0.01. Order sizes are shown in column 304. The lowest ask price is 95.26 with a quantity of 25 contracts. The highest bid price is 95.25 with a quantity of 25 contracts. The minimum bid ask spread is the difference between 95.26 and 95.25, which is the same as the minimum trading increment of 0.01. The criteria used in step 204 may require that the combined quantity of the lowest ask and the highest bid orders to be at least 100 contracts. FIG. 3 shows a combined quantity of the lowest ask and the highest bid of 50 contracts. In step 206 the minimum bid ask spread may be dynamically adjusted by aggregating resting and incoming orders. FIG. 4 shows that state of the market after the price of the orders for 25 contracts at price 95.26 have been changed to a price of 95.27. The orders are aggregated with the initial orders for 45 contracts at a price of 95.27 to result in orders for 70 contracts at a price of 95.27. Similarly, the price of the orders initially at the price of 95.25 may be changed to a price of 95.24 and aggregated with the initial orders for 25 contracts to result in orders for 60 contracts at a price of 95.24.

FIG. 4 shows that the combined quantity of the lowest ask and the highest bid orders to be 130, which exceeds the criteria of 100 contracts used in the example. FIG. 4 also shows that the trading increment remains at 0.01, while the minimum bid ask spread, which is the difference between 92.27 and 95.24, is forced to be at least 0.03 while this criteria is in effect. Of course additional aggregation may be performed to reach other criteria. For example, the orders for 70 contracts at a price of 95.27 may be aggregated with the 75 orders at 95.28. The resulting combined quantity of the lowest ask and the highest bid orders would be 205 contracts. In other embodiments, the criteria may include a minimum quantity at the highest bid or the lowest ask. Still other embodiments may include a minimum quantity at both the highest bid and the lowest ask.

The process shown in FIG. 2 may be iterative. For example, after it is determined that the bid ask spread meets the predetermined criteria in step 204, in step 208 the process may wait a predetermined time period and return to step 204 to determine whether the bid ask spread meets the predetermined criteria. The predetermined time period in step 208 may be less than a second, several seconds, several minutes, several hours or several days. The predetermined time period may be a function of the type of financial instrument or any of the various volatility factors described above. After the dynamic adjustment in step 206, the process may wait a predetermined time period in step 210 and once again determine whether the bid ask spread meets the predetermined criteria in step 212. The predetermined time period in step 210 may be similar to the predetermined time period in step 208. When the predetermined criteria is not met in step 212, the process may return to step 206 so that the minimum bid ask spread may be dynamically adjusted to meet the predetermined criteria.

When the predetermined criteria is met in step 212, in step 214 the process may determine whether the original bid ask spread meets the predetermined criteria. When the original bid ask spread meets the predetermined criteria, in step 216 the process may return to the original bid ask spread. Step 216 may include undoing the aggregation of orders. In alternative embodiments, the process may check for other bid ask spread levels between the current bid ask spread level and the original bid ask spread level. After step 216 the process again waits a predetermined time period in step 210 and then returns to step 212.

When orders have been aggregated in accordance with the processes described above, in some embodiments the orders that have undergone a price change may receive priority when matching. For example, if an ask order was aggregated and had a price increase, the ask order would have priority when orders are matched at the higher price level. In some embodiments, when orders that had prices changed are matched, those matched orders may be executed at the original order price instead of the changed price. An exchange or other entity may publish the rules so that all criteria are known to traders. Traders may develop new strategies to take advantage of the potential price changes and priority matching.

In some embodiments of the invention trading increments may also be dynamically adjusted in response to various criteria. Some embodiments include adjustments to trading increments and bid ask spreads.

Various embodiments of the invention may also use an adaptive match engine which draws upon different matching algorithms, e.g. the rules which dictate how a given order should be allocated among qualifying resting orders, depending upon market conditions, to improve the operation of the market. For example, a first-in/first-out (FIFO) matching algorithm, also referred to as a “Price Time” algorithm, considers each identified order sequentially in accordance with the best price and next, when the identified order was received. The quantity of the incoming order is matched to the quantity of the identified order with the best price that was received earliest, then quantities of the orders with the same price that were received next earliest, and so on until the orders at the best price are exhausted, then the matching algorithm moves on the next best price with orders that were received earliest, and so on until the quantity of the incoming order is exhausted. Some product specifications define the use of a pro-rata matching algorithm, wherein a quantity of an incoming order is allocated to each of a plurality of identified orders proportionally in the order of best prices. Some exchange computer systems provide a priority to certain standing orders in particular markets. An example of such an order is the first order that improves a price (i.e., improves the market) for the product during a trading session. To be given priority, the trading platform may require that the quantity associated with the order is at least a minimum quantity. Further, some exchange computer systems cap the quantity of an incoming order that is allocated to a standing order on the basis of a priority for certain markets. In addition, some exchange computer systems may give a preference to orders submitted by a trader who is designated as a market maker for the product. Other exchange computer systems may use other criteria to determine whether orders submitted by a particular trader are given a preference. Typically, when the exchange computer system allocates a quantity of an incoming order to a plurality of identified orders at the same price, the trading host allocates a quantity of the incoming order to any orders that have been given priority. The exchange computer systems thereafter allocates any remaining quantity of the incoming order to orders submitted by traders designated to have a preference, and then allocates any still-remaining quantity of the incoming order using the FIFO or pro-rata algorithms. Pro-rata algorithms used in some markets may require that an allocation provided to a particular order in accordance with the pro-rata algorithm must meet at least a minimum allocation quantity. Any orders that do not meet or exceed the minimum allocation quantity are allocated to on a FIFO basis after the pro-rata allocation (if any quantity of the incoming order remains). More information regarding order allocation may be found in U.S. Pat. No. 7,853,499, the entirety of which is incorporated by reference herein.

Other examples of matching algorithms which may be defined for allocation of orders of a particular financial product include:
Price Explicit Time
Order Level Pro Rata
Order Level Priority Pro Rata
Preference Price Explicit Time
Preference Order Level Pro Rata
Preference Order Level Priority Pro Rata
Threshold Pro-Rata
Priority Threshold Pro-Rata
Preference Threshold Pro-Rata
Priority Preference Threshold Pro-Rata
Split Price-Time Pro-Rata

For example, the Price Explicit Time trading policy is based on the basic Price Time trading policy with Explicit Orders having priority over Implied Orders at the same price level. The order of traded volume allocation at a single price level may therefore be:
Explicit order with oldest timestamp first. Followed by
Any remaining explicit orders in timestamp sequence (First In, First Out—FIFO) next. Followed by
Implied order with oldest timestamp next. Followed by
Any remaining implied orders in timestamp sequence (FIFO).

In Order Level Pro Rata, also referred to as Price Pro Rata, priority is given to orders at the best price (highest for a bid, lowest for an offer). If there are several orders at this best price, equal priority is given to every order at this price and incoming business is divided among these orders in proportion to their order size. The Pro Rata sequence of events is:
1. Extract all potential matching orders at best price from the order book into a list.
2. Sort the list by order size, largest order size first. If equal order sizes, oldest timestamp first. This is the matching list.
3. Find the Matching order size, which is the total size of all the orders in the matching list.
4. Find the ‘tradable volume’, which is the smallest of the matching volume and the volume left to trade on the incoming order.
5. Allocate volume to each order in the matching list in turn, starting at the beginning of the list. If all the tradable volume gets used up, orders near the end of the list may not get allocation.
6. The amount of volume to allocate to each order is given by the formula: (Order volume/Matching volume)*Tradable volume
   The result is rounded down (for example, 21.99999999 becomes 21) unless the result is less than 1, when it becomes 1.
7. If tradable volume remains when the last order in the list had been allocated to, return to step 3.
   Note: The matching list is not re-sorted, even though the volume has changed. The order which originally had the largest volume is still at the beginning of the list.
8. If there is still volume left to trade on the incoming order, repeat the entire algorithm at the next price level.

Order Level Priority Pro Rata, also referred to as Threshold Pro Rata, is similar to the Price (or ‘Vanilla’) Pro Rata algorithm but has a volume threshold defined. Any pro rata allocation below the threshold will be rounded down to 0. The initial pass of volume allocation is carried out in using pro rata; the second pass of volume allocation is carried out using Price Explicit Time. The Threshold Pro Rata sequence of events is:
1. Extract all potential matching orders at best price from the order book into a list.
2. Sort the list by explicit time priority, oldest timestamp first. This is the matching list.
3. Find the ‘Matching volume’, which is the total volume of all the orders in the matching list.
4. Find the ‘tradable volume’, which is the smallest of the matching volume and the volume left to trade on the incoming order.
5. Allocate volume to each order in the matching list in turn, starting at the beginning of the list.
6. The amount of volume to allocate to each order is given by the formula: (Order volume/Matching volume)*Tradable volume
   The result is rounded down to the nearest lot (for example, 21.99999999 becomes 21) unless the result is less than the defined threshold in which case it is rounded down to 0.
7. If tradable volume remains when the last order in the list had been allocated to, the remaining volume is allocated in time priority to the matching list.
8. If there is still volume left to trade on the incoming order, repeat the entire algorithm at the next price level.

In the Split Price Time Pro-Rata algorithms, a Price Time Percentage parameter is defined. This percentage of the matching volume at each price is allocated by the Price Explicit Time algorithm and the remainder is allocated by the Threshold Pro-Rata algorithm. There are four variants of this algorithm, with and without Priority and/or Preference. The Price Time Percentage parameter is an integer between 1 and 99. (A percentage of zero would be equivalent to using the respective existing Threshold Pro-Rata algorithm, and a percentage of 100 would be equivalent to using the respective existing Price Time algorithm). The Price Time Volume will be the residual incoming volume, after any priority and/or Preference allocation has been made, multiplied by the Price Time Percentage. Fractional parts will be rounded up, so the Price Time Volume will always be at least 1 lot and may be the entire incoming volume. The Price Time Volume is allocated to resting orders in strict time priority. Any remaining incoming volume after the Price Time Volume has been allocated will be allocated according to the respective Threshold Pro-Rata algorithm. The sequence of allocation, at each price level, is therefore:
1. Priority order, if applicable
2. Preference allocation, if applicable
3. Price Time allocation of the configured percentage of incoming volume
4. Threshold Pro-Rata allocation of any remaining incoming volume
5. Final allocation of any leftover lots in time sequence.
   Any resting order may receive multiple allocations from the various stages of the algorithm.

It will be appreciated that there may be other allocation algorithms, including combinations of algorithms, now available or later developed, which may be utilized with the disclosed embodiments, and all such algorithms are contemplated herein.

Prior matching systems apply a single algorithm, or combined algorithm, to all of the orders received for a particular financial product to dictate how the entire quantity of the incoming order is to be matched/allocated. In contrast, the disclosed embodiments may apply different matching algorithms, singular or combined, to different orders, as will be described, recognizing that the allocation algorithms used by the trading host for a particular market may, for example, affect the liquidity of the market. Specifically, some allocation algorithms may encourage traders to submit more orders, where each order is relatively small, while other allocation algorithms encourage traders to submit larger orders. Other allocation algorithms may encourage a trader to use an electronic trading system that can monitor market activity and submit orders on behalf of the trader very quickly and without intervention. As markets and technologies available to traders evolve, the allocation algorithms used by trading hosts must also evolve accordingly to enhance liquidity and price discovery in markets, while maintaining a fair and equitable market.

The present invention has been described herein with reference to specific exemplary embodiments thereof. It will be apparent to those skilled in the art, that a person understanding this invention may conceive of changes or other embodiments or variations, which utilize the principles of this invention without departing from the broader spirit and scope of the invention as set forth in the appended claims. All are considered within the sphere, spirit, and scope of the invention.

1. A method comprising:
(a) determining a minimum bid ask spread for a financial instrument having a fixed trading increment; and
(b) by a processor dynamically adjusting the minimum bid ask spread to meet a predetermined criteria while not adjusting a trading increment.

2. The method of claim 1, wherein (b) comprises aggregating resting and incoming orders at a price level.

3. The method of claim 2, wherein (b) comprises reducing a price of at least one bid order.

4. The method of claim 3, wherein (b) comprises increasing a price of at least one ask order.

5. The method of claim 2, further comprising:
(c) at a processor matching orders for the financial instrument.

6. The method of claim 5, wherein (c) comprises giving priority to orders that had a price change in (b).

7. The method of claim 1, wherein the predetermined criteria comprises a minimum order quantity for orders at a highest bid price or lowest ask price.

8. The method of claim 1, wherein the predetermined criteria comprises implied volatility of the financial instrument.

9. The method of claim 1, wherein the predetermined criteria comprises realized volatility of the financial instrument.

10. The method of claim 1, wherein the predetermined criteria comprises volatility of an underlying financial instrument.

11. The method of claim 1, wherein the predetermined criteria comprises a volume of trades of the financial instrument during a time period or the level of open interest during a time period.

12. A financial instrument trading system comprising:
a processor;
a tangible computer readable medium could be processor and containing computer-executable instructions that when executed cause the processor to perform the steps comprising:
(a) maintaining an initial minimum bid ask spread for a financial instrument having a fixed trading increment; and
(b) dynamically adjusting the minimum bid ask spread to meet a predetermined criteria while not adjusting a trading increment.

13. The financial instrument trading system of claim 12, wherein (b) comprises aggregating resting and incoming orders at a price level.

14. The financial instrument trading system of claim 13, wherein (b) comprises reducing a price of at least one bid order.

15. The financial instrument trading system of claim 14, wherein (b) comprises increasing a price of at least one ask order.

16. The financial instrument trading system of claim 13, further comprising:
(c) matching orders for the financial instrument.

17. The financial instrument trading system of claim 16, wherein (c) comprises giving priority to orders that had a price change in (b).

18. A non-transitory computer-readable medium containing computer-executable instructions that when executed cause a processor to perform the steps comprising:
(a) maintaining an initial minimum bid ask spread for a financial instrument having a fixed trading increment; and
(b) dynamically adjusting the minimum bid ask spread to meet a predetermined criteria while not adjusting a trading increment.

19. The non-transitory computer-readable medium of claim 18, wherein (b) comprises aggregating resting and incoming orders at a price level.

20. The non-transitory computer-readable medium of claim 19, wherein (b) comprises reducing a price of at least one bid order.

21. A method comprising:
(a) determining a minimum bid ask spread for a financial instrument having a fixed trading increment;
(b) by a processor dynamically adjusting the minimum bid ask spread to meet a predetermined criteria; and
(c) by a processor dynamically adjusting a minimum trading increment to meet a predetermined criteria.
